(19) United States
(12) Patent Application Publication
(10) Pub. No.: US 2003/0177938 A1
(43) Pub. Date: Sep. 25, 2003

(54) Travel way support

(76) Inventors: Dieter Reichel, Neumarkt (DE); Erich Lindner, Auerbach (DE); Ralf Waidhauser, Neumarkt (DE)

Correspondence Address: Stephen E Bondura, Dority & Manning, Post Office Box 1449, Greenville, SC, 29602-1449, US

(21) Appl. No.: 10/129,886

(22) PCT Filed: Sep. 1, 2001
(86) PCT No.: PCT/EP01/10098

(30) Foreign Application Priority Data
Sep. 12, 2000 (DE) 10045336.8
Dec. 22, 2000 (DE) 10064724.3

(51) Int. Cl. B60L 13/04

(52) U.S. Cl. 104/282

(57) ABSTRACT

The invention relates to a travel way support, particularly for a magnetically levitated train (100), for constructing a travel way through a number of supports (2) successively arranged in the direction of travel. Said travel way support comprises an upper support section (12), particularly an upper flange (12) and at least one bracing section (13, 14), in particular, a web (13, 14), which is arranged underneath the upper support section (12). Solar cells (7, 8) and/or solar collectors are arranged in the area of the upper support section (12) and/or of the at least one bracing section (13, 14).

The invention relates to a travel way support, in particular for a Magnetically levitated train, to constitute a travel way with several supports following each other in the direction of travel, with at least one upper support section, in particular an upper flange and with at least one bracing section, in particular a web located beneath the upper support section.

Travel way supports of this type have large surfaces. It is the object of the present invention to further develop such a travel way support that a simple but highly efficient utilization of free surfaces is realized on the travel way support.

This object is attained with the travel way support mentioned initially by means of solar cells and/or solar collectors installed in the area of the upper support section and/or of at least one bracing section.

The invention furthermore proposes the utilization of solar cells and/or solar collectors for attachment in the area of a travel way support located or capable of being located essentially above ground, with at least one upper support section and at least one bracing section.

The advantages of the invention are in particular due to the fact that such installed solar cells and/or solar collector make it possible to make good use of the free support surfaces. The current produced by the solar cells in particular can be used for example to power the monitoring systems of the travel way or the vehicles. Alternatively or in addition, measuring devices can be powered with the current, e.g. temperature and moisture measuring instruments. In addition the current can be used alternatively or in addition for a system controlling the temperature of the support material. If the support material is concrete, for example, it can be heated during winter operation by means of imbedded metal wires. In addition it is possible for example to illuminate advertising displays attached on other free surfaces or to power illuminated letters with the current of the solar cells. For the latter purpose, electrical energy already available on the travel way can be used e.g. on rainy days.

The heat produced by the solar collectors can also be used to generate current as well as to heat edifices, including parts of the travel way support itself. Cooling of edifices is also possible with the help of heat pumps.

Within the framework of the invention, all suitable types of solar cells can be used, e.g. thin-film solar arrays with high power-weight ratio. The utilization of flexible support materials for solar cells, e.g. made of plastic, is also possible since the solar cells can be rolled together in that case and thus large surfaces of the travel way support can easily be covered.

An additional advantage of the utilization of solar cells and/or solar collectors according to the invention with a travel way support of the type mentioned initially consists in the fact that especially solar cells and/or solar collectors installed on the upper side can protect the support itself from direct sun radiation so that uneven warming and accompanying deformation of the support section can be avoided or reduced. Thereby closer tolerances can be respected for the support.

The travel way can also be designed as a bivalent travel way on which a magnetic levitation train as well as conventional trains, with a considerably narrower rail gauge, can be operated.

It has been shown statistically and from the manufacturing point of view to be advantageous if the travel way support is given a hollow cross-section, in particular if is used for a magnetically levitated train. For this two support sections or webs across from each other are preferably provided, which are connected to each other via the upper support section or upper flange. The hollow space is advantageously closed up on the underside by a lower support section or lower flange. The support sections can have inclined sections directed towards the sun in this case, so that the solar cells or solar collectors attached to them supply current or heat in an efficient manner.

In case of relatively short curve radii it is indicated to give the travel way support a full cross-section so that only a bracing section is provided under the upper support section. Solar cells and/or solar collectors are then located on one or both sides on the bracing section.

The travel way support is preferably supported on one or more pillars sunk in the ground. This distribution makes good constructive processing of the support possible during manufacture as well as relatively easy installation on the site. Furthermore the space under the travel way support can be used. The solar cells and/or solar collectors installed high above ground are relatively safe from unauthorized access by third parties.

The individual travel way supports are preferably successively arranged so that the distance between the support sections following each other is small or negligible. In the extreme case a continuous sequence of supports results in which the bracing sections form a kind of wall in the direction of the travel way to which the solar cells and/or solar collectors can be attached. In this manner a great number of solar cells and/or solar collectors can be installed on the travel way.

The solar cells and/or solar collectors are preferably attached directly to the free outer surfaces of the support. The solar cells and/or solar collectors thus clad these surfaces, so that especially in strong winds barely any attack surface is provided that could result in the solar cells and/or solar collectors being torn out of their attachments on the support.

Due to the fact that a travel way support may have relatively large dimensions, it is advantageous for reasons of easier handling to install several smaller fields of solar cells and/or solar collectors next to each other in the direction of the travel way. This arrangement furthermore facilitates the replacement of damaged individual fields.

If the support is designed so that the surfaces and/or masses of the support exposed to the rays of the sun are similar to each other at the first and the second flange, it is especially advantageous to provide for a low temperature gradient inside the support. This means that the heating of the support near the first flange and near the second flange is substantially even so that the expansion of the first flange or the second flange is not greater than that of the other flange. Bending of the support due to different heating can thus be extensively avoided.

In order to promote even heating and expansion of the support, at least some parts of the outside of the support have a heat-absorbing or reflective surface. Thereby an uneven sunlight irradiation on the different parts of the support can for example be evened out, so that again uniform expansion of the support takes place.

The heat absorbing and/or reflective surface can be applied to the support in form of a coat of paint. In this manner the different thermal characteristics of the support can easily be preserved.

If shading elements are provided for at least some parts of the outside of the support, this measure also serves to maintain a low temperature gradient of the support. The operating characteristics of the support can be adjusted thereby to the most varied sun irradiations.

In an inventive manner, means for heat compensation, in particular for heat exchange are provided between the first flange and the second, or additional flanges for a support of the type described earlier. If the support is heated unevenly by sun irradiation for example, it would be deformed in an undesirable manner due to the temperature gradient thus produced. The precisely aligned components built on would no longer possess the required precision, so that the operation of e.g. a magnetically levitated train could no longer be ensured. By providing heat compensation or heat exchange means it becomes possible that the heat generated when a first flange is heated more strongly is transmitted to the second flange, so that the latter is also heated and expands in similar manner as the first flange. The heat can be introduced in a targeted manner into the areas of the support that are expected to be heated less or that have a greater mass and thus require more time to heat up.

Circuits with heat-carrying liquids, in particular oil, have proven themselves for the heat exchange. The heat is transported through these circuits from more strongly heated areas of the support into less heated areas of the support.

Cooling and/or heating elements are advantageous as active means for heat compensation. These cooling and/or heating elements which can be operated e.g. by solar cells, can also hold down the temperature gradient inside the support when necessary and can thus avoid the deformation of the support to an extensive degree.

Advantageous further developments of the invention are presented through the characteristics of the sub-claims.

The invention is explained in further detail below with the help of the drawing.

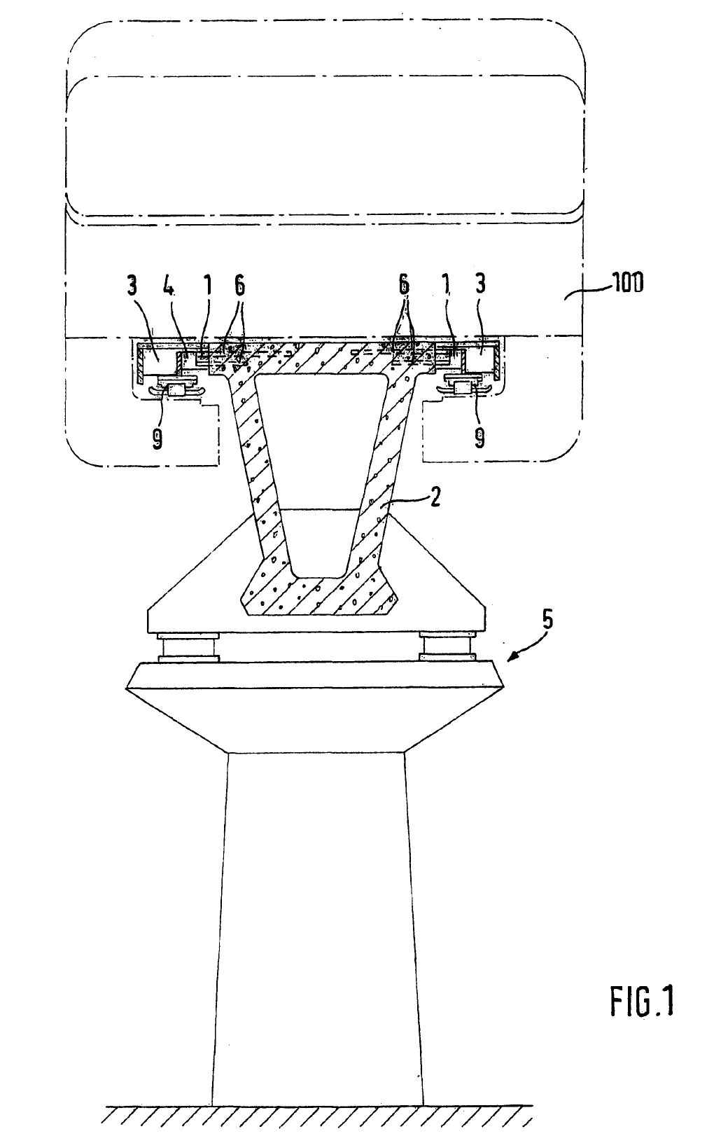

FIG. 1 shows a travel way with a magnetically levitated train;

FIG. 2 shows an alternative embodiment of a travel way support seen in cross-section, with solar cells, and

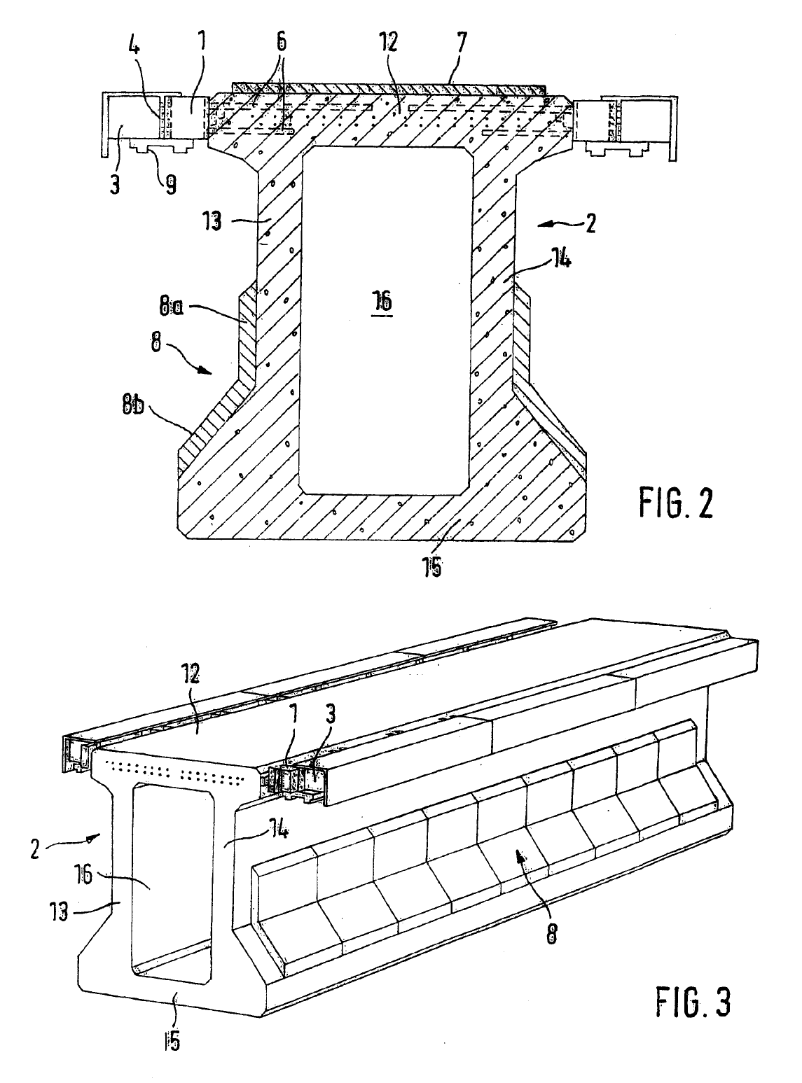

FIG. 3 shows a perspective view of the travel way support according to FIG. 2;

FIG. 4 shows a cross-section through a support with heat compensation and

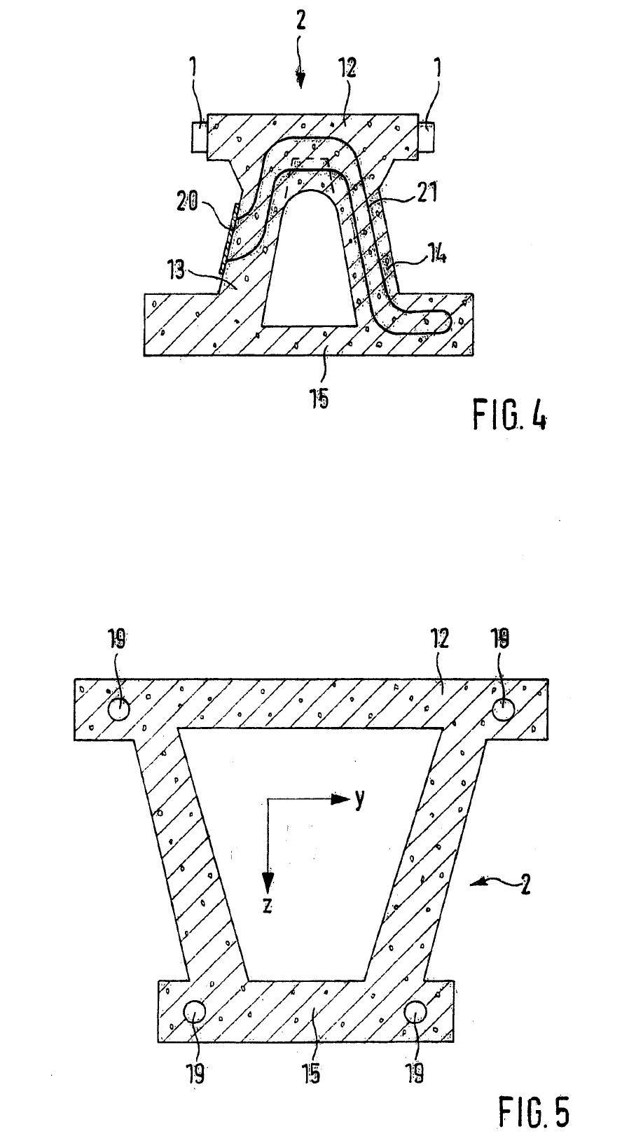

FIG. 5 shows a cross-section through yet another support.

As an example, the invention is described through a hybrid support system for rail-operated vehicles. EP 0 987 370 A1 of which the contents of the disclosure are enclosed herewith, describes such a support system in detail.

FIG. 1 shows a travel way for a magnetically levitated train 100 in cross-section. Supports 2 made preferably of prestressed concrete are attached to pillars 5 at the site. Several supports 2 are set up here successively arranged in the direction of the travel way. The front of the supports 2 are in this case adjoining each other directly. Connection brackets 1 preferably made of steel are installed on the sides on each support 2 at even distances. Every connection bracket 1 is welded or screwed to tie rods 6 that are imbedded in the concrete of the support 2. Each connection bracket 1 is provided with a head plate 4 to which the functional plane support 3 is attached to receive e.g. stator packages 9.

FIGS. 2 and 3 show an alternative embodiment of a support 2 provided with an upper support section 12 in form of an upper flange 12, two horizontal support sections 13, 14 in form of bracing section 13, 14 as well as a lower support section 15 in form of a lower flange 15. The flanges 12, 15 and the bracing section 13, 14 delimit a hollow space 16 with a nearly rectangular cross-section. The attachment of functional plane supports 3 on connection brackets 1 is substantially unchanged from the embodiment according to FIG. 1.

According to the invention, solar cells 8 are installed on the outside on the bracing section 13, 14 for the production of current. The solar cells 8 shown in FIGS. 2 and 3 have two sections 8a, 8b at an angle to each other which are adapted to the downward widening form of the bracing sections 13, 14. Several fields with solar cells 8 adjoining each other directly are installed in the direction of the travel way.

As can be seen in FIG. 1, the magnetically levitated train 100 surrounds the connection brackets 1 and the functional plane support 3 until close to the bracing section 13, 14. The solar cells 8 are not pulled up to the upper flange 12 but end with an upper edge below the magnetically levitated train 100. Since the solar cells 8 only have a small diameter it is of course also possible to install solar cells 8 also to the bracing sections directly across from the magnetically levitated train.

On the side of the upper flange 12 pointing upward solar cells 7 are also installed left out in FIG. 3 and are preferably adjoining each other and occupy nearly the entire width of the upper flange 12. The height of the solar cells 7 is here advantageously selected so that the functioning of the travel of the magnetically levitated train 100 is not impaired. In particular by covering the upper flange 12 with solar cells 7 excessive heating of the support 2 effectively is avoided. Of course the solar cells 8 on the bracing section 13, 14 contribute to this also. In this manner critical deformation of the concrete and thereby of the travel way can be avoided.

For the sake of clarity, no solar cells 7, 8 are drawn in FIG. 1. The above descriptions apply however without restrictions also to this embodiment of the travel way.

It is furthermore possible, to attach solar cells alternatively or in addition to the pillars 5 which come in that case under the concept of travel way supports and in particular the concept of support section according to the claims of this invention.

External surface sections to which no solar cells 7, 8 are attacked can be used as advertising surfaces that can be illuminated by the current produced by the solar cells 7, 8. The current of the solar cells 7, 8 can be used alternatively or in addition to monitoring devices, measuring devices and similar devices.

The above description for the attachment of solar cells on the travel way support can also be applied without restriction to the identical attachment of solar collectors.

According to FIG. 4, solar cells 20 are installed on the bracing section 4′. In this embodiment it is assumed that the web 13 receives more sun exposure than web 14. As a result it must be expected that the side of the webn 13 would heat up more and would thus lead to a deformation of the support 2 if no heat compensation took place. This heat compensation is achieved by means of the solar cell 20 and a circuit 21 connected to it. The circuit 21 conveys a heat carrying liquid from the side exposed to the sunrays to the side of the support 2 that is in the shadow. As a result the web 14 and the lower chord 15 are also heated up. This in turn causes the heat expansion to be similar on both sides of the support 2 so that the deformation of the support 2 remains within a tolerable range. A similar heat compensation can take place between the upper chord and the lower chord if a heat transfer, e.g. from the upper chord 12 to the lower chord 15 results from a suitable placement of the circuits 21. Alternatively to the shown solar cells 20 it is possible to ensure the insulation or heat absorption of the support by means of a painted coats, heat insulating elements, cooling or heating elements as well as shading devices.

FIG. 5 shows another alternative embodiment of a support 2 in cross-section. In the chords 12 and 15, in their outer area, prestressing steel elements 19 is provided without being combined with the concrete. By installing the prestressing steel elements 19 in the outer areas of the chords 12 and 15, in particular if the prestressing steel element 19 is designed so that it is still accessible after having been built into the support 2, an adjustment of the support 2 in directions y and z is possible. This adjustment in directions y and z is obtained by a suitable post-stressing of the different prestressing steel elements 19 so that the support 2 is drawn in a predetermined manner. In this way a precise adjustment of the support 2 to fit the requirements of the travel way can be made e.g. in case of sinking of the underground, thermal effects on the support or other changes in the line. The adjustment can be done in a particularly sensitive manner by using presses that are controlled in function of temperature that stress the relevant prestressing steel elements 19 to a greater or lesser degree to compensate for the deformation of the support 1 by one-sided heating. The presses can be connected e.g. to corresponding solar cells.

The construction of the support according to the invention makes it possible to produce single-span supports for the construction of a line for the magnetically levitated train that can be maintained in with particular positional accuracy. Although single-span supports clearly sag more than multi-span supports, the heat compensation and the change in prestressing steel elements make it possible to keep sagging within admissible minimal tolerances.

1. Travel way support, particularly for a magnetically levitated train (100), for constructing a travel way through a number of supports (2) successively arranged in the direction of travel with an upper support section (12), particularly an upper flange (12) and at least one bracing section (13, 14), in particular a web (13, 14) which is arranged underneath the upper support section (12), characterized by solar cells (7, 8) and/or solar collectors arranged in the area of the upper support section (12) and/or of the at least one bracing section (13, 14).

2. Travel way support as in claim 1, characterized by a configuration that is hollow in its cross-section, whereby the hollow space (16) is delimited at the top by the upper support section, at either side by a bracing section (13, 14) and at the bottom by a lower support section (15).

3. Travel way support as in claim 1 or 2, characterized by installation on one or more pillars (5) imbedded in the ground.

4. Travel way support as in one of the preceding claims, characterized in that the faces of the bracing section (13, 14) across from each other and belonging to two supports (2) following each other are essentially connected to each other.

5. Travel way support as in one of the preceding claims, characterized in that the solar cells (7, 8) and/or solar collectors are installed on at least one of the surfaces facing out of the at least one bracing section (13, 14) and/or of the upper support section (12).

6. Travel way support as in one of the preceding claims, characterized in that several fields of solar cells (7, 8) and/or solar collectors are arranged next to each other in the direction of the travel way.

7. Travel way support as in one of the preceding claims, characterized by a configuration as a bivalent travel way, e.g. for magnetically levitated trains as well as for conventional trains.

8. Travel way support, in particular as in one of the preceding claims, characterized in that the surfaces and/or masses of the support (2) exposed to the rays of the sun are similar on the first flange (12) and on the second flange (15) to receive a low temperature gradient.

9. Travel way support as in one of the preceding claims, characterized in that at least portions of the outside of the support (2) have a heat absorbing and/or heat reflecting surface.

10. Travel way support as in one of the preceding claims, characterized in that at least portions of the outside of the support (2) are provided with a coat of paint.

11. Travel way support as in one of the preceding claims, characterized in that at least portions of the outside of the support (2) are provided with shading elements.

12. Travel way support, in particular as in one of the preceding claims, characterized in that means for heat compensation, in particular for heat exchange are provided between the first flange (12) and the second flange (15).

13. Travel way support as in one of the preceding claims, characterized in that the means for heat compensation (21) are circuits (21) with heat-carrying liquid, in particular oil.

14. Travel way support as in one of the preceding claims, characterized in that the means for heat compensation are cooling and/or heating elements.

15. Travel way support as in one of the preceding claims, characterized in that a prestressing steel element (19) is provided without connection in the outer area of the flanges (12; 15).

16. Travel way support as in one of the preceding claims, characterized in that prestressing elements are provided in central position between the bracing section (13, 14).

17. Travel way support as in one of the preceding claims, characterized in that the centered prestressing elements are thermally insulated.

18. Travel way support as in one of the preceding claims, characterized in that the support (2) can be deformed in particular through one-sided heating of the relevant prestressing element by means of presses controlled in function of temperature.

19. Travel way support as in one of the preceding claims, characterized in that the presses are connected with corresponding solar cells and/or solar collectors.

20. Utilization of solar cells and/or solar collectors for attachment in the area of travel way support installed above ground or that can be installed above ground with an upper support section (12) and at least one bracing section (13, 14), in particular a travel way support (20 as in one of the preceding claims.

21. Utilization of solar cells and/or solar collectors as in one of the preceding claims, characterized in that free surfaces of the at least one bracing section (13, 14) and/or of the upper support section are covered with them.

22. Utilization of solar cells as in one of the preceding claims, characterized in that the current produced by the solar cells is used for illuminated advertising, to supply monitoring systems, to supply measuring devices and/or to regulate the temperature of the support material.
